(19) United States
(12) Patent Application Publication
(10) Pub. No.: US 2012/0094867 A1
(43) Pub. Date: Apr. 19, 2012

(54) High-Throughput Molecular Rotor Viscometry Assay

(75) Inventors: Sang-Kyu Lee, Palo Alto, CA (US); Sandra W. Ramer, Sunnyvale, CA (US); Amr R. Toppozada, San Francisco, CA (US)

(73) Assignee: Danisco US Inc., Palo Alto, CA (US)

(21) Appl. No.: 13/320,879

(22) PCT Filed: May 25, 2010
(86) PCT No.: PCT/US10/36028

§ 371 Date: Dec. 8, 2011

Related U.S. Application Data
(60) Provisional application No. 61/184,751, filed on Jun. 5, 2009.

(51) Int. Cl. C40B 30/10

(52) U.S. Cl. 506/12

(57) ABSTRACT

Described are compositions and methods related to determining the rate of viscosity change in a suspension in real time. The compositions and methods have a broad range of applications, including the measurement of amylase-mediated liquefaction of a starch suspension.

### PRIORITY

The present application claims priority to U.S. Provisional Patent Application Ser. No. 61/184,751, filed on Jun. 5, 2009, which is hereby incorporated by reference in its entirety.

### TECHNICAL FIELD

The present compositions and methods relate to determining the rate of viscosity change in a suspension in real time. The compositions and methods have a broad range of applications, including the measurement of amylase-mediated liquefaction of a starch suspension.

### BACKGROUND

The rotational viscometer is a standard tool for assessing the starch liquefaction performance of alpha (α)-amylases in the laboratory. However, the process of obtaining rotational viscometer data is slow and requires a large quantity of enzyme, rendering the rotational viscometer assay unsuitable for use as a primary screening method for industrial protein engineering. Alternative small-scale assays that indirectly measure changes in viscosity often give erroneous or unpredictable results, also rendering them unsuitable for use as a primary screening method. Thus, the need exists for more convenient, more accurate, and more reproducible viscosity assays.

### SUMMARY

Described is a high-throughput, molecular rotor viscometry assay for determining the change in viscosity of a suspension in real time. The method generally involves adding a molecular rotor to a suspension containing a substrate capable of being converted to a product, where conversion of the substrate to the product changes the viscosity of the suspension, adding an enzyme or chemical catalyst to the suspension to initiate conversion of the substrate to the product, and measuring the fluorescence (RFU) of the molecular rotor, wherein the change in fluorescence of the molecular rotor can be correlated with the change in viscosity of the suspension. This change in viscosity can further be used to determine the rate of change in viscosity, the rate of conversion of the substrate to the product, the amount of substrate converted to product, and the like.

In one aspect, a method for determining the change in viscosity of a suspension in real time is provided, comprising: adding to a suspension containing a substrate capable of being converted to a product a molecular rotor molecule whose fluorescence quantum yield is dependent on the free-volume of the suspension and an enzyme or chemical catalyst capable of converting the substrate to the product; and measuring the fluorescence of the molecular rotor molecule in the suspension in real time; wherein conversion of the substrate to the product changes the free-volume of the suspension as determined by measuring the fluorescence of the molecular rotor molecule, and wherein the change in the free-volume of the suspension correlates with the change in viscosity of the solution.

In some embodiments, the change in viscosity of the suspension is used to determine the rate of conversion of the substrate to the product. In some embodiments, the change in viscosity of the suspension is used to determine the amount of substrate converted to product.

In some embodiments, the suspension is a starch suspension. In some embodiments, the suspension is a corn amylopectin suspension. In other embodiments, the suspension is a cellulose suspension, or a mixed starch and cellulose suspension.

In some embodiments, the enzyme is a carbohydrate processing enzyme. In some embodiments, the enzyme is an amylase, glucoamylase, pullulanase, cellulase, hemicellulase, or combination thereof. In particular embodiments, the enzyme is an amylase.

In some embodiments, the conversion of the substrate to the product is the amylase-mediated liquefaction of a starch suspension to produce lower molecular weight dextrans.

In some embodiments, the molecular rotor molecule is 9-(2-carboxy-2-cyanovinyl)-julolidine (CCVJ).

In some embodiments, the method is performed in a multi-well format. In particular embodiments, the method is performed in a 6-well, 12-well, 24-well, or 96-well format.

These and other aspects and embodiments of the compositions and methods will be apparent in view of the description and accompanying drawings.

### BRIEF DESCRIPTION OF THE DRAWINGS

FIG. 1 shows a plot of the decrease in fluorescence (RFU) of a molecular rotor as a function of time (seconds) in a starch hydrolysis reaction. The decrease in fluorescence was correlated with a decrease in suspension viscosity due to starch hydrolysis.

FIG. 2 shows peak viscosity data obtained using a conventional rotational viscometer assay, which confirmed the results obtained using the molecular rotor viscometry assay.

### DETAILED DESCRIPTION

### I. Definitions

Prior to describing the present compositions and methods in detail, the following terms and phrases are defined for clarity. Terms and phrases not defined should be given their ordinary meaning as used in the art.

As used herein, a “molecular rotor molecule” or simply a “molecular rotor” is a fluorescent chemical entity whose fluorescence quantum yield (i.e., the number of photons emitted divided by the number of photons absorbed) is dependent on the free-volume of its microenvironment, e.g., in a suspension.

As used herein, the term “real time” refers to the measurement of an event as it occurs.

As used herein, the term “starch” refers to materials comprsing polysaccharides having the general formula (C₆H₁₀O₅)ₙ, wherein the sugar substituents of the polysaccharides are linked primarily by α-D-(1→4) and/or α-D-(1→6) glycosidic bonds.

As used herein, the term “cellulose” refers to materials comprsing polysaccharides having the general formula (C₆H₁₀O₅)ₙ, wherein the sugar substituents of the polysaccharides are linked primarily by β-D-(1→4) glycosidic bonds.

As used herein, the term “carbohydrate processing enzyme” refers to any enzyme capable of hydrolyzing at least one component present in a starch and/or cellulose composition. Exemplary enzymes include amylases, glucoamylases, pullulanases, cellulases, hemicellulases, and combinations, thereof.

As used herein, the terms “amylase,” “amylolytic enzyme,” or “amylase enzyme” refer to an enzyme that is, among other things, capable of catalyzing the degradation of starch. Amylases are hydrolases that cleave the α-D-(1→4) O-glycosidic linkages in starch. Generally, α-amylases (EC 3.2.1.1; α-D-(1→4)-glucan glucanohydrolase) are defined as endo-acting enzymes cleaving α-D-(1→4) O-glycosidic linkages within the starch molecule in a random fashion. In contrast, the exo-acting amylolytic enzymes, such as β-amylases (EC 3.2.1.2; α-D-(1→4)-glucan maltohydrolase) and some product-specific amylases like maltogenic α-amylase (EC 3.2.1.133) cleave the starch molecule from the non-reducing end of the substrate. β-amylases, α-glucosidases (EC 3.2.1.20; α-D-glucoside glucohydrolase), glucoamylase (EC 3.2.1.3; α-D-(1→4)-glucan glucohydrolase), and product-specific amylases can produce malto-oligosaccharides of a specific length from starch.

As used herein, the terms “cellulase,” “cellulolytic enzyme,” or “cellulase enzyme” refer to a category of enzymes capable of hydrolyzing cellulose polymers to shorter cello-oligosaccharide oligomers, cellobiose and/or glucose.

As used herein, the term “multi-well format” refers to an assay arrangement involving a matrix of samples on a common solid support, e.g., 6-well, 12-well, 24-well, or 96-well plates.

Unless otherwise specified, the articles “a,” “an,” and “the” refer to both the singular and plural referents. All reference cited, herein, are hereby incorporated by reference in their entirety.

### II. High-Throughput Molecular Rotor Viscometry Assay

A high-throughput molecular rotor viscometry assay was developed using a commercially available molecular rotor to monitor the liquifaction of a starch substrate. Generally, a molecular rotor is a fluorescent species whose quantum yield (i.e., the number of photons emitted divided by the number of photons absorbed) is dependent on the free-volume of the microenvironment, which is related to the viscosity of the microenvironment. For such molecules, the preferred mode of relaxation from the excited state is intramolecular rotation, which is inhibited in an amount proportional to the viscosity of the microenvironment. The balance of energy is dissipated through radiative relaxation (fluorescent emission), which can be measured, thereby allowing the viscosity of the microenvironment to be calculated.

To measure the rate of viscosity reduction due to enzymatic activity on a substrate, the molecular rotor CCVJ (9-(2-carboxy-2-cyanovinyl)julolidine) was incorporated into a buffered suspension of corn amylopectin, which was then distributed to the wells of a 96-well plate. An amount of one of a number of α-amylase polypeptides was then added to different wells containing the CCVJ/corn amylopectin suspension to initiate an enzymatic starch hydrolysis reaction. The reaction was carried out in a Spectramax M2 96-well fluorometer running in kinetic mode at room temperature, with data collection being performed in real time. The preparation of the reagents used in the assay and experimental procedures are described in the Examples.

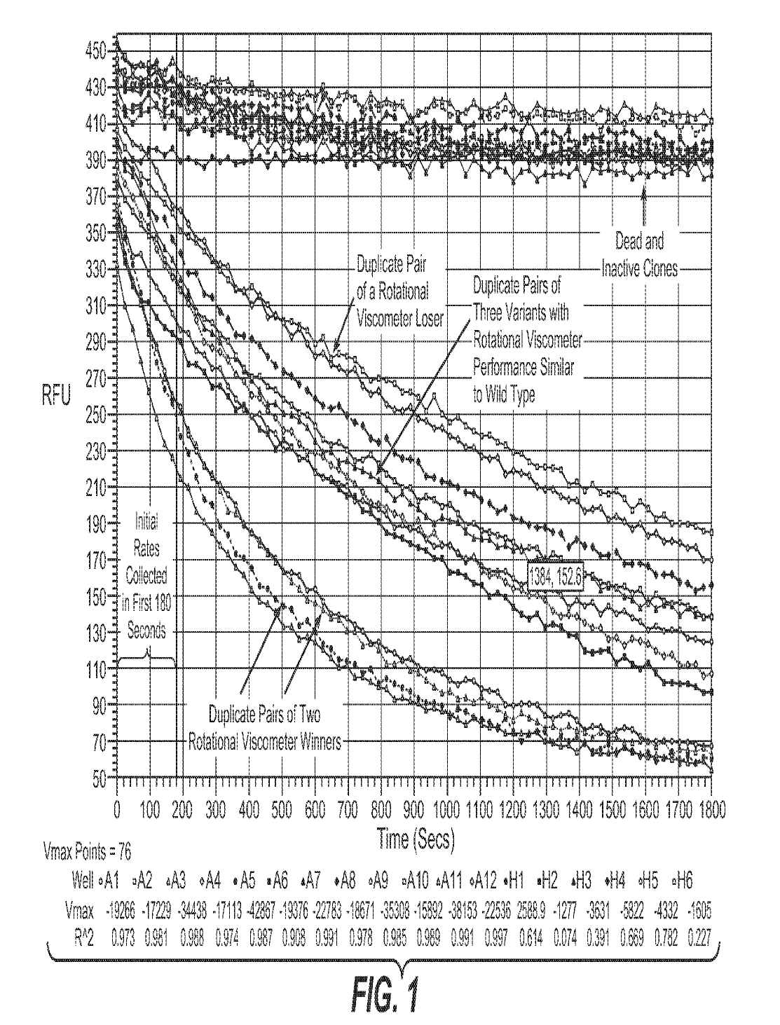

The rate of viscosity reduction due to enzymatic starch hydrolysis was determined by measuring the rate of reduction in fluorescent signal from CCVJ. Kinetic rates of fluorescent signal reduction were automatically calculated as “Vmax (milli-units per min)” by Softmax Pro, the sofware packaged with Spectramax instruments. A plot of the raw kinetic data relating to enzyme-mediated fluorescence (viscosity) reduction over time is shown in FIG. 1 The rate of decrease in fluorescence (RFU, y-axis) is proportionate to the rate of amylase-mediated viscosity reduction. A lower value indicated better performance in terms of starch hydrolysis activity. 27 variant α-amylases demonstrated superior performance to the wild-type enzyme in the molecular rotor assay.

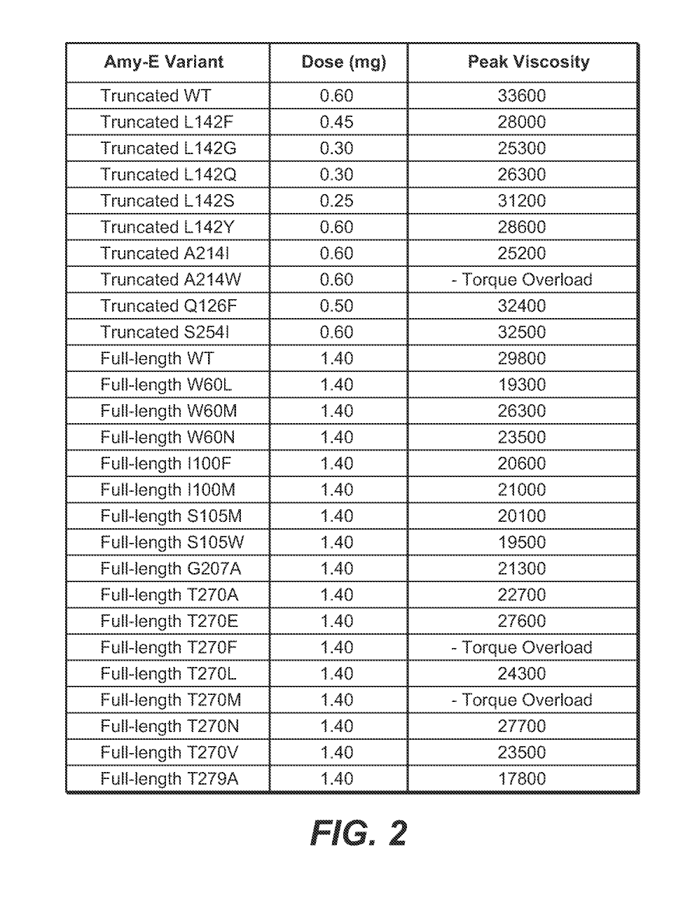

To determine whether the results of the molecular rotor assay accurately reflected the starch hydrolysis activity of the variant α-amylases, a conventional rotational viscometer assay was used to evaluate the same variant α-amylases. A table showing the enzyme dose and peak viscosity values obtained is shown in FIG. 2. Of the 27 variants that demonstrated superior performance in the molecular rotor assay, 24 were confirmed to have superior performance using more cumbersome rotational viscometer assay. These results demonstrate the efficacy and accuracy of the methods.

Exemplary molecular rotors for use in the present assays include but are not limited to 9-(2-carboxy-2-cyanovinyl)-julolidine (CCVJ) and 9-(dicyanovinyl)-julolidine (DCVJ), and alkyl esters, thereof, 1-(2-hydroxyethyl)-6-[(2,2-dicyano)vinyl]-2,3,4-trihydroquinoline (DCQ), 4,4′-difluoro-4-bora-3a,4a-diazo-s-indacene, thioflavin T (ThT), p-[(2-cyano-2-propanediol ester)vinyl]dimethylaniline, and the like.

### Utility

The present assay allows the direct monitoring, in real time, of the kinetic rate of viscosity reduction in a suspension. The speed, simplicity, robustness, reproducibility, and amenability to automation make the assay well-suited to high-throughput screening, where is can generate data at a rate of about 1,000 times faster than a conventional rotational viscometer assay.

Uses for the assay include measuring viscosity changes in enzyme-mediated and other reactions that produce a change in viscosity of a reaction mixture suspension. An exemplary reaction is the amylase-mediated liquefaction of a starch suspension to produce lower molecular weight dextrans. Related reaction involve the liquefaction of a starch suspension mediated by a glucoamylase, pullulanase, amylase, or combinations, thereof, and the liquefaction of a cellulose suspension mediated by a cellulase, hemicellulase, or combinations, thereof.

### EXAMPLES

A 100 mM stock solution of CCVJ was prepared by adding 186 μL of dimethyl sulfoxide to a vial containing 5 mg of lyophilized CCVJ (Sigma Aldrich Corporation, St. Louis, Mo.). The CCVJ stock solution was stored in the dark at room temperature and checked for precipitation prior to use. 90 g of amylopectin from corn (MP Biomedicals LLC, Solon, Ohio) were added to 2,850 μL of distilled water, which was heated to boiling with constant stiffing, under which conditions the amylopectin gradually gelatinized and dissolved. The resulting, uniformly-viscous suspension of 5% gelled amylopectin was removed from the heat source and stirred continuously as it returned to room temperature, at which point 150 mL of 1 M sodium acetate buffer (pH 5.8) (which was previously prepared by titrating 1 M sodium acetate with 1 M acetic acid) were added, followed by 150 μL of Tween-80 (Sigma Aldrich Corporation, St. Louis, Mo.). When the Tween-80 was completely dissolved, 150 μL of the 100 mM CCVJ stock solution were added and dissolved (5 μM final concentration), at which point the amylopectin/CCVJ reagent was complete and ready for use. The reagent was stored in clear glass at room temperature with constant stirring for the duration of the three days required to complete a viscometry screening assay.

All liquid-handling were performed by a Biomek FX^{P} robot equipped with a multichannel head that enabled the simultaneous pipetting of all 96 wells of a 96-well microtiter plate. 60 μL of amylopectin/CCVJ reagent were added to each well of a black untreated polystyrene 96-well microtiter plate (Coming Incorporated, Corning, N.Y.). 30 μL of enzyme (100 ppm α-amylase) sample were pipetted on top of this and the microtiter plate was immediately read on a Spectramax M2e fluorometer (Molecular Devices Corporation, Sunnyvale, Calif.) that was set up as follows: top-read fluorescence mode; excitation wavelength 435 nanometers (nm); emission wavelength 495 nm; cutoff wavelength 455 nm; kinetic read mode with 24-second read interval; 15-second shake before initial read, 3-second shake between reads; 192 seconds total read time with a 20-second lag period (eliminating from each kinetic rate calculation the first of the 9 data points collected). Typical results are shown in FIG. 1. Based on results obtained using the molecular rotor viscosity assay, 27 α-amylase variants were identified as having high levels of starch liquefaction activity. The data were compared to those obtained using a standard rotational viscometer assay, which confirmed that 24 of the variants had high levels of starch liquefaction activity (FIG. 2), demonstrating the accuracy of the molecular rotor assay.

Other features, aspects, and embodiments of the present compositions will be apparent in view of the description and accompanying drawings.

1. A method for determining the change in viscosity of a suspension in real time, comprising:
adding to a suspension containing a substrate capable of being converted to a product a molecular rotor molecule whose fluorescence quantum yield is dependent on the free-volume of the suspension and an enzyme or chemical catalyst capable of converting the substrate to the product; and
measuring the fluorescence of the molecular rotor molecule in the suspension in real time;
wherein conversion of the substrate to the product changes the free-volume of the suspension as determined by measuring the fluorescence of the molecular rotor molecule, and wherein the change in the free-volume of the suspension correlates with the change in viscosity of the solution.

2. The method of claim 1, wherein the change in viscosity of the suspension is used to determine the rate of conversion of the substrate to the product.

3. The method of claim 1, wherein the change in viscosity of the suspension is used to determine the amount of substrate converted to product.

4. The method of claim 1, wherein the suspension is a starch suspension.

5. The method of claim 1, wherein the suspension is a corn amylopectin suspension.

6. The method of claim 1, wherein the enzyme is a carbohydrate processing enzyme.

7. The method of claim 6, wherein the enzyme is an amylase.

8. The method of claim 1, wherein the conversion of the substrate to the product is the amylase-mediated liquefaction of a starch suspension to produce lower molecular weight dextrans.

9. The method of claim 1, wherein the molecular rotor molecule is 9-(2-carboxy-2-cyanovinyl)-julolidine (CCVJ).

10. The method of claim 1, performed in a multi-well format.
